(19) United States
(12) Patent Application Publication
(10) Pub. No.: US 2026/0181587 A1
(43) Pub. Date: Jun. 25, 2026

(54) WIRELESS RANGING CALIBRATION FOR DEVICE PAIR PROFILES

(71) Applicant: Google LLC, Mountain View, CA (US)

(72) Inventors: Qi Jiang, San Jose, CA (US); Li-Xuan Chuo, San Jose, CA (US); Chin-Wei Hsu, Sunnyvale, CA (US)

(21) Appl. No.: 18/999,408

(22) Filed: Dec. 23, 2024

(51) Int. Cl. H04W 64/00

(52) U.S. Cl. CPC H04W 64/006

(57) ABSTRACT

Techniques are described for an example computing device including a storage device that stores instructions executable by processing circuitry to: determine a signal metric for a ranging signal sent to an external computing device; determine, based on the signal metric, a measured distance between the computing device and the external computing device; compare the measured distance to a set distance between the computing device and the external computing device; determine, based on the comparison, an offset distance for the ranging signal; generate, based on the offset distance, a device-pair calibration profile for the computing device and the external computing device; and determine, based on the device-pair calibration profile, a distance between the computing device and the external computing device, wherein the distance between the computing device and the external computing device is used to trigger one or more actions associated with the computing device or the external computing device.

### BACKGROUND

Computing devices, especially portable or handheld devices, typically include a multitude of wireless communication components, such as components for GPS (global positioning system), Bluetooth® LE (low energy), Wi-Fi®, ZigBee®, and Ultra-Wideband®. Computing devices may implement wireless communication components and one or more wireless ranging protocols to determine distances between the computing devices and external computing devices.

### SUMMARY

In general, techniques of this disclosure are directed to calibrating an offset for distance determinations between a pair of devices. A first computing device may determine distances between the first computing device and a second computing device to perform one or more actions (e.g., unlocking the second computing device based on a determined distance between the first computing device and the second computing device, controlling the second computing device based on a determined distance between the first computing device and the second computing device, etc.). The first computing device may determine the distances between the first computing device and the second computing device according to a device-pair calibration profile associated with a pair of devices including the first computing device and the second computing device. The device-pair calibration profile may indicate, for a pair of devices (e.g., the first computing device and the second computing device), one or more offset distances that may be implemented to accurately determine a distance between the pair of devices according to a wireless ranging protocol (UWB, BLUETOOTH Channel Sounding, WIFI RTT, etc.). Offset distances associated with a pair of devices may be specific to devices of the pair of devices, such as a distance between wireless communication components of each of the devices.

The first computing device may determine a device-pair calibration profile for the first computing device and the second computing device based on enrollment ranging information associated with the first computing device and the second computing device. For example, the first computing device may use an enrollment ranging signal (e.g., BLUETOOTH, UWB, etc.) to determine an enrollment signal metric between the first computing device and the second computing device. The first computing device may compare a measured distance, determined based on the enrollment signal metric, to a set distance between the first computing device and the second computing device (e.g., comparing measured and actual distances). The first computing device may determine an offset distance for the ranging signal based on a difference between the set distance and the measured distance. The first computing device may generate a device-pair calibration profile for the first computing device and the second computing device to include the offset distance. The first computing device may implement the device-pair calibration profile to calibrate ranging signals associated with the first computing device and the second computing device when determining a distance between the first computing device and the second computing device (e.g., compensating for delays introduced by various components based on the offset distance included in the device-pair calibration profile). The first computing device and/or the second computing device may perform an action responsive to a distance between the first computing device and the second computing device, determined based on the device-pair calibration profile, satisfying a threshold.

In some aspects, the techniques described herein relate to a method including: determining, by a first computing device, a signal metric for a ranging signal sent to a second computing device; determining, by the first computing device and based on the signal metric, a measured distance between the first computing device and the second computing device; comparing, by the first computing device, the measured distance between the first computing device and the second computing device to a set distance between the first computing device and the second computing device; determining, by the first computing device and based on the comparison, an offset distance for the ranging signal; generating, based on the offset distance, a device-pair calibration profile for the first computing device and the second computing device; and determining, by the first computing device and based on the device-pair calibration profile, a distance between the first computing device and the second computing device, wherein the distance between the first computing device and the second computing device is used to trigger one or more actions associated with the first computing device or the second computing device.

In some aspects, the techniques described herein relate to a computing device that includes: one or more processors; and a storage device that stores instructions executable by the one or more processors to: determine a signal metric for a ranging signal sent to an external computing device; determine, based on the signal metric, a measured distance between the computing device and the external computing device; compare the measured distance between the computing device and the external computing device to a set distance between the computing device and the external computing device; determine, based on the comparison of the measured distance to the set distance, an offset distance for the ranging signal; generate, based on the offset distance, a device-pair calibration profile for the computing device and the external computing device; and determine, based on the device-pair calibration profile, a distance between the computing device and the external computing device, wherein the distance between the computing device and the external computing device is used to trigger one or more actions associated with the computing device or the external computing device.

In some aspects, the techniques described herein relate to a computer-readable storage medium storing instructions that, when executed, cause one or more processors of a computing device to: determine a signal metric for a ranging signal sent to an external computing device; determine, based on the signal metric, a measured distance between the computing device and the external computing device; compare the measured distance between the computing device and the external computing device to a set distance between the computing device and the external computing device; determine, based on the comparison of the measured distance to the set distance, an offset distance for the ranging signal; generate, based on the offset distance, a device-pair calibration profile for the computing device and the external computing device; and determine, based on the device-pair calibration profile, a distance between the computing device and the external computing device, wherein the distance between the computing device and the external computing device is used to trigger one or more actions associated with the computing device or the external computing device.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing environment with an example first computing device configured to perform wireless ranging calibration for example device pair profiles associated with one or more of a set of example computing devices, in accordance with one or more aspects of the present disclosure.

FIG. 2 is a block diagram illustrating an example computing device configured to perform wireless ranging calibration for determining example device pair profiles, in accordance with one or more aspects of the present disclosure.

FIG. 3 is a conceptual diagram illustrating one example of a first example computing device performing wireless ranging calibration with an example second computing device to determine a device pair profile, in accordance with aspects of the present disclosure.

FIG. 4 is a conceptual diagram illustrating one example of a first example computing device performing wireless ranging calibration with an example second computing device to determine a device pair profile, in accordance with one or more aspects of the present disclosure.

FIG. 5 is a block diagram illustrating an example offset distance for a device pair profile associated with an example first computing device and an example second computing device, in accordance with one or more aspects of the present disclosure.

FIG. 6 is a flow diagram illustrating an operation for determining a device pair calibration profile, in accordance with one or more aspects of the present disclosure.

### DETAILED DESCRIPTION

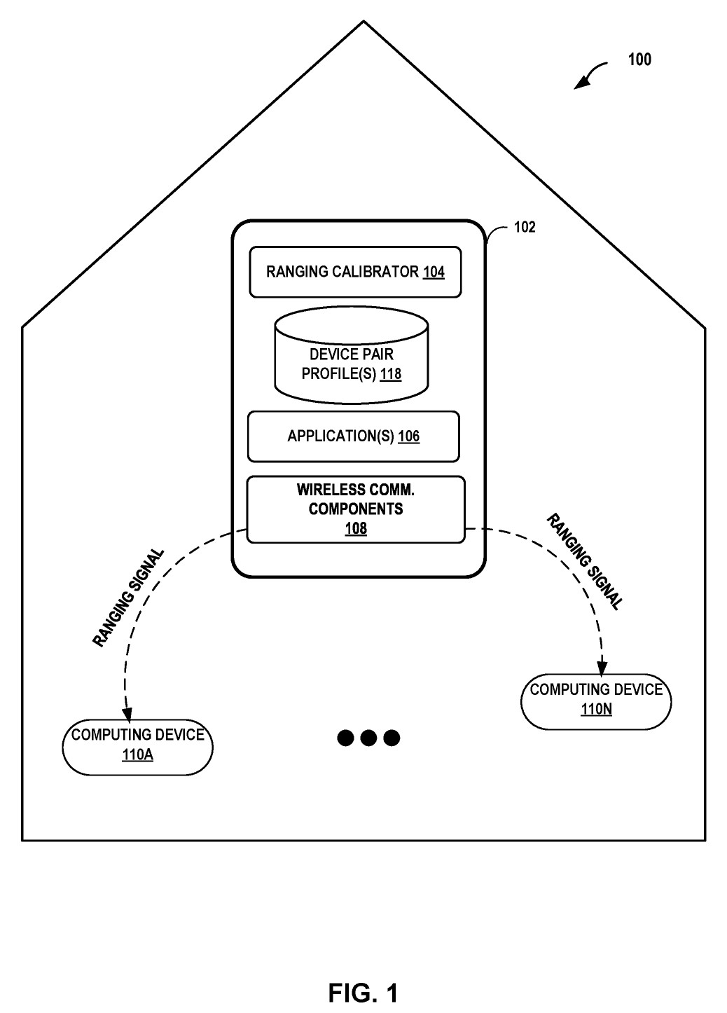

FIG. 1 is a conceptual diagram illustrating example computing environment 100 with example first computing device 102 configured to perform wireless ranging calibration for example device pair profiles 118 associated with one or more of set of example computing devices 110A–110N (collectively referred to herein as “computing devices 110”), in accordance with one or more aspects of the present disclosure. Computing environment 100 may include a home, a parking lot, an office space, a public venue, or an environment outside of a manufacturing facility associated with computing device 102. Computing environment 100, in the example of FIG. 1, may include computing device 102 and computing devices 110. Computing device 102 and computing devices 110 may include a mobile phone, a tablet computer, a laptop computer, a desktop computer, a wearable device (e.g., a computerized watch, computerized eyewear, computerized headphones, computerized gloves, etc.), a virtual reality or augmented reality device, a spatial computing device, a server, a mainframe, a set-top box, a television, a home automation device or system (e.g., an intelligent thermostat or home assistant device), a gaming system, a media player, an e-book reader, a television platform, an automobile navigation or infotainment system, or any other type of mobile, non-mobile, wearable, and non-wearable computing device configured to implement wireless ranging protocols (e.g., Ultra-Wideband, UWB, ranging, a local area network ranging protocol such as WIFI round trip time protocol, personal area network ranging protocol such as a BLUETOOTH channel sounding protocol, Near Field Communication, NFC, ranging, infrared ranging, etc.).

Wireless communication components 108 may include components for implementing one or more wireless ranging protocols. For example, wireless communication components 108 may include components for implementing UWB ranging protocols (e.g., a UWB transceiver, a timing unit, a signal processor, etc.), components for implementing BLUETOOTH ranging (e.g., a BLE chip, a BLE transceiver, a measurement unit, antennas, modules, etc.), or the like. Applications 106 may use wireless communication components 108 to determine a distance between computing device 102 and one or more of computing devices 110 according to various wireless ranging protocols. Applications 106 may trigger events based on a distance determined using wireless ranging protocols. For example, applications 106 may unlock access to resources associated with computing device 110A based on using wireless ranging protocols associated with BLUETOOTH, Near Field Communication (NFC), WIFI, or the like to determine whether a distance between computing device 102 and computing device 110A satisfies a distance threshold.

Different wireless ranging protocols may inherently have different accuracy capabilities. However, common problems associated with distance determination accuracy of wireless ranging protocols may include offset distances associated with wireless communication components (e.g., chips, modules, antennas, etc.) of a pair of computing device 102 and a device involved in a distance determination and/or conditions associated with an orientation of computing device 102 with respect to the device involved in the distance determination. Computing device 102, according to the techniques described herein, may improve distance determinations associated with wireless ranging protocols by maintaining device pair profiles 118 indicating offset distances for computing device 102 and enrolled devices (e.g., any of computing devices 110) and/or indicating conditions associated with an orientation of computing device 102 when triggering an action based on a determined distance. In this way, computing device 102 may improve a user’s experience associated with triggering actions based on accurate distance determinations.

In accordance with the techniques described herein, computing device 102 may generate one or more device pair profiles 118 indicating calibrations for distance determinations between computing device 102 and one or more of computing devices 110 within computing environment 100. Device pair profiles 118 may include a device-pair calibration profile (also referred to herein as “device pair profile”) associated with an enrollment of a computing device of computing devices 110. An enrollment of a computing device of computing devices 110 may at least include establishing parameters, associated with one or more wireless ranging protocols, for determining a distance between computing device 102 and the computing device of computing devices 110. Computing device 102 may initiate enrollment of a computing device by comparing a set distance between computing device 102 and the computing device (e.g., determined at the start of enrollment) to a measured distance between computing device 102 and the computing device (e.g., measured during enrollment using one or more wireless ranging protocols) to ascertain parameters (e.g. offset distances between wireless communication components of first computing device 102 and wireless communication components of the computing device) used for accurately determining a distance between computing device 102 and the computing device. In this way, computing device 102 may quickly and accurately determine a distance between computing device 102 and a particular computing device, with particular component arrangements, to trigger actions based on the distance.

In operation, ranging calibrator 104 of computing device 102 may generate device pair calibration profiles for device pair profiles 118. For example, ranging calibrator 104 may receive an indication (e.g., based on a user input) to enroll computing device 110A. Ranging calibrator 104 may instruct wireless communication components 108 to send a ranging signal to computing device 110A. Ranging calibrator 104 may determine a signal metric (e.g., round-trip propagation metrics, two-way signal measurements, round-trip time, round-trip phase, etc.) for the ranging signal sent to computing device 110A, where the signal metric is associated with a ranging method used by a particular wireless ranging protocol associated with the ranging signal. Ranging calibrator 104 may determine, based on the signal metric, a measured distance between computing device 102 and computing device 110A.

Ranging calibrator 104 may compare a measured distance between first computing device 102 and computing device 110A to a set distance between computing device 102 and computing device 110A. For example, ranging calibrator 104 may, prior to determining a measured distance between computing device 102 and computing device 110A, determine a set distance between computing device 102 and computing device 110A as a distance between a housing of computing device 102 and a housing of computing device 110A. In some instances, ranging calibrator 104 may determine a set distance as a distance between a housing of computing device 102 and a housing of computing device 110A when computing device 102 has a specific orientation (e.g., angled at a 45 degree angle with respect to the horizon). In some examples, ranging calibrator 104 may determine a set distance based on a predetermined distance associated with triggering an action (e.g., a predetermined distance of 30 centimeters between computing device 102 and computing device 110A to trigger an action of unlocking resources of computing device 110A).

Ranging calibrator 104 may determine an offset distance for a ranging signal sent between first computing device 102 and computing device 110 based on a comparison of a measured distance to a set distance. For instance, ranging calibrator 104 may determine an offset distance for ranging or enrollment signals sent between the pair of computing device 102 and computing device 110A as the difference between a measured value between computing device 102 and computing device 110A and a set distance between computing device 102 and computing device 110A. Ranging calibrator 104 may determine the offset distance of the pair of computing device 102 and computing device 110A as a distance associated with signal delays of wireless communication components (e.g., chips, modules, antennas, etc.) of computing device 102 and wireless communication components of computing device 110.

Ranging calibrator 104 may generate a device-pair calibration profile for computing device 102 and computing device 110A based on a determined offset distance. For example, ranging calibrator 104 may generate a device-pair calibration profile for the pair of computing device 102 and computing device 110 as a data structure indicating a determined offset distance. In some examples, ranging calibrator 104 may generate a device-pair calibration profile to include indications of an orientation of computing device 102 when offset distances were determined. In some instances, ranging calibrator 104 may generate a device-pair calibration profile to include indications of motion of computing device 102 with respect to a device to be enrolled (e.g., changes in distance between computing device 102 and computing device 110A associated with triggering an action) to further improve accuracy associated with distance determinations for triggering actions. Ranging calibrator 104 may store device-pair calibration profiles as device pair profiles 118. In some examples, ranging calibrator 104 may calibrate a wireless ranging system (e.g., a system, such as a smart home, associated with interconnecting computing device 102 and computing devices 110) based on device-pair calibration profiles.

Applications 106 may implement device-pair calibration profiles of device pair profiles 118 to determine distances between computing device 102 and enrolled devices. For example, a software application of applications 106 may be configured to unlock resources associated with computing device 110A responsive to determining a distance between computing device 102 and computing device 110A satisfies a threshold (e.g., within 30 centimeters). The software application may access a device-pair calibration profile associated with computing device 110A to obtain parameters for the pair of computing device 102 and computing device 110A (e.g., an offset distance associated with wireless communication components of the pair of computing device 102 and computing device 110A, positional or orientation information of associated with computing device 102 triggering an unlock procedure of computing device 110A, etc.). The software application may implement, based on signals detected using wireless communication components 108, one or more wireless ranging protocols using parameters (e.g., the offset distance, positional or orientation information, etc.) obtained from a device-pair calibration profile of device pair profiles 118 to determine a distance between computing device 102 and computing device 110A. For example, the software application may determine a signal metric for a ranging signal sent to computing device 110A, such as a round-trip time (e.g., for UWB protocols, WIFI protocols, etc.) and/or a round-trip phase (e.g., for BLUETOOTH Channel Sounding protocols). The software application may compute the distance between computing device 102 and computing device 110A based on the signal metric and an offset distance indicated in a device-pair calibration profile associated with computing device 102 and computing device 110A (e.g., offset a preliminary distance determined with the signal metric by an offset distance indicated in a device pair profile to compute the distance).

Applications 106 may trigger one or more actions based on a determined distance between computing device 102 and enrolled devices. For example, based on a software application of applications 106 determining, using wireless ranging protocols based on parameters of device pair profiles 118, a distance between computing device 102 and computing device 110A satisfies a threshold, the software application may execute an action using application instances executing at computing device 102 and/or computing device 110A (e.g., application instances executing at computing device 102 and computing device 110A initiate an unlock procedure to unlock resources associated with computing device 110A). In another example, based on a software application of applications 106 determining, using wireless ranging protocols based on parameters of device pair profiles 118, a change in distance (e.g., motion) between computing device 102 and computing device 110A follows a particular pattern, the software application may trigger an action associated with computing device 110A (e.g., send information such as images or videos currently displayed at computing device 102 to computing device 110A.

The techniques of this disclosure include one or more advantages. For example, rather than calibrating a single device during manufacturing, computing device 102 may calibrate distance determinations for a pair of devices. Computing device 102 may improve accuracy of distance determinations using wireless ranging protocols by calibrating pairs of devices in a way that is device specific, application specific, and/or specific to an orientation or position of computing device 102. In this way, computing device 102 may calibrate distance determinations via wireless ranging protocols outside of a manufacturing setting (e.g., calibrating distance determinations after distribution to potentially reduce test time associated with a factory calibrating computing device 102 with each potential use case), in a way that adapts to use cases particular to computing device 102 (e.g., adapts to how a user holds or wears computing device 102 when attempting to trigger an action based on a distance determination via wireless ranging protocols).

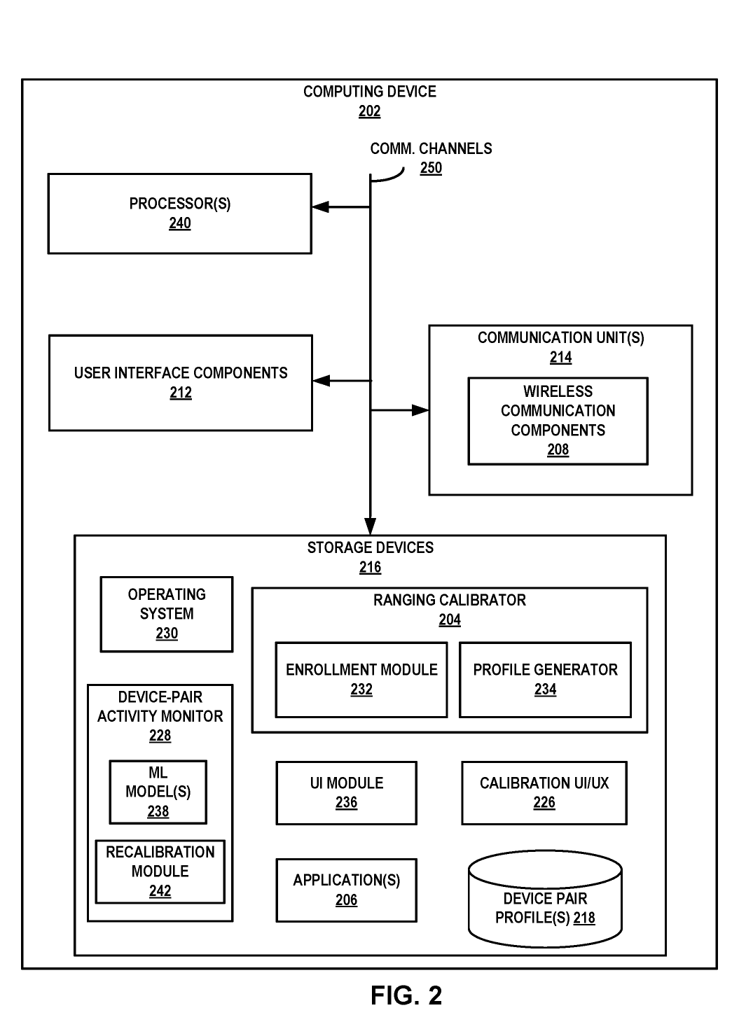

FIG. 2 is a block diagram illustrating an example computing device configured to perform wireless ranging calibration for determining example device pair profiles, in accordance with one or more aspects of the present disclosure. Computing device 202, wireless communication components 208, ranging calibrator 204, and device pair profiles 218 of FIG. 2 may be example or alternative implementations of computing device 102, wireless communication components 108, ranging calibrator 104, and device pair profiles 118 of FIG. 1, respectively. Computing device 202 may include one or more processors 240 (“processor 240”), user interface components (UIC) 212, communication units 214, storage devices 216, and communication channels 250 (“COMM channel 250”). COMM channel 250 may interconnect each of the components 240, 212, 214, and 216 for inter-component communications (physically, communicatively, and/or operatively). In some examples, communication channel 250 may include a system bus, a network connection, an inter-process communication data structure, or any other method for communicating data.

UIC 212 may function as an input and/or output device for computing device 202. UIC 212 may be implemented using various technologies. For instance, UIC 212 may function as an input device using presence-sensitive input screens, microphone technologies, infrared sensor technologies, or other input device technology for use in receiving user input. UIC 212 may function as an output device configured to present output to a user using any one or more display devices, speaker technologies, haptic feedback technologies, or other output device technology for use in outputting information to a user.

UIC 212 may detect input (e.g., touch and non-touch input) from a user of computing device 202. UIC 212 may detect indications of input by detecting one or more gestures performed by a user (e.g., the user touching, pointing, and/or swiping at or near one or more locations of UIC 212 with a finger or a stylus pen). UIC 212 may output information to a user in the form of a user interface, which may be associated with functionality provided by computing device 202.

Communication units 214 of computing device 202 may communicate with one or more external devices via one or more wired and/or wireless networks by transmitting and/or receiving network signals on the one or more networks. Examples of communication units 214 may include a network interface card (e.g., Ethernet card), an optical transceiver, a radio frequency transceiver, a GNSS receiver, or any other type of device that can send and/or receive information. Other examples of communication units 214 may include short wave radios, cellular data radios (for terrestrial and/or satellite cellular networks), wireless network radios, as well as USB controllers. In the example of FIG. 2, communication units 214 may include wireless communication components 208 for implementing one or more wireless ranging protocols.

One or more processors 240 (“processor 240”) may implement functionality and/or execute instructions within computing device 202. For example, processor 240 may receive and execute instructions that provide the functionality of ranging calibrator 204, one or more applications 206, device-pair activity monitor 228, calibration UI/UX 226, device pair profiles 218, UI module 236, and/or operating system (OS) 230. These instructions executed by processor 240 may cause computing device 202 to store and/or modify information within storage devices 216 or processor 240 during program execution. Processor 240 may execute instructions of ranging calibrator 204, one or more applications 206, device-pair activity monitor 228, calibration UI/UX 226, device pair profiles 218, UI module 236, and/or OS 230 to perform one or more operations. That is ranging calibrator 204, one or more applications 206, device-pair activity monitor 228, calibration UI/UX 226, device pair profiles 218, UI module 236, and/or OS 230 may be operable by processor to perform various functions described herein.

One or more storage devices 216 (referred to herein as “storage devices 216”) may store information for processing during operation of computing device 202 (e.g., computing device 202 may store data accessed by ranging calibrator 204, one or more applications 206, device-pair activity monitor 228, calibration UI/UX 226, device pair profiles 218, UI module 236, and/or OS 230 during execution at computing device 202). In some examples, storage devices 216 may include temporary memory, meaning that a primary purpose of storage devices 216 is not long-term storage. Storage devices 216 may be configured for short-term storage of information as volatile memory and therefore not retain stored contents if powered off. Examples of volatile memories include random access memories (RAM), dynamic random access memories (DRAM), static random access memories (SRAM), and other forms of volatile memories.

Storage devices 216 may include one or more computer-readable storage media. Storage devices 216 may be configured to store larger amounts of information than volatile memory. Storage devices 216 may further be configured for long-term storage of information as non-volatile memory space and retain information after power on/off cycles. Examples of non-volatile memories include magnetic hard discs, optical discs, flash memories, or forms of electronically programmable memories (EPROM) or electronically erasable and programmable (EEPROM) memories. Storage devices 216 may store program instructions and/or information associated with ranging calibrator 204, one or more applications 206, device-pair activity monitor 228, calibration UI/UX 226, device pair profiles 218, UI module 236, and/or OS 230.

OS 230 may control operation of components of computing device 202. For example, OS 230 may facilitate the communication of ranging calibrator 204, one or more applications 206, device-pair activity monitor 228, calibration UI/UX 226, device pair profiles 218, UI module 236, and/or OS 230 with processor 240, communication units 214, UIC 212, and storage devices 216. In some examples, OS 230 may manage interactions between software applications (e.g., one or more applications 206) and a user of computing device 202. OS 230 may have a kernel that facilitates interactions with underlying hardware of computing device 202 and provides a fully formed application space capable of executing a wide variety of software applications having secure partitions in which each of the software applications executes to perform various operations.

UI module 236 may manage user interactions with UIC 212 and other components of computing device 202. In other words, UI module 236 may act as an intermediary between various components of computing device 202 to make determinations based on indications of user inputs detected by UIC 212 and generate output at UIC 212 in response to the user inputs. UI module 236 may receive instructions from an application, service, platform, or other module of computing device 202 to cause UIC 212 to output graphical user interfaces.

Ranging calibrator 204 may include enrollment module 232 and profile generator 234. Enrollment module 232 may include computer readable instructions for determining parameters (e.g., offset distance, positional or orientation information, motion or change in distance to trigger action information, etc.) for determining distances between computing device 202 and a device to be enrolled using one or more wireless ranging protocols. For example, enrollment module 232 may instruct wireless communication components 208 to send a ranging signal as an enrollment ranging signal with a timestamp to a device to be enrolled. Enrollment module 232 may obtain an indication of a response signal, detected using wireless communication components 208, from the device to be enrolled that may include information associated with processing time taken by the device to be enrolled when receiving the enrollment ranging signal and sending the response signal (e.g., a turnaround time). Enrollment module 232 may record a time of arrival of the response signal based on a timestamp included in the response signal sent by the device to be enrolled. Enrollment module 232 may calculate a signal metric (e.g., round-trip time, round-trip phase, etc.) of the enrollment ranging signal based on a difference between a timestamp associated with arrival of a response signal and a timestamp associated with sending an initial enrollment signal. In some instances, enrollment module 232 may initiate enrollment of an external computing device (e.g., send enrollment ranging signals to an external computing device to determine an offset distance for a pair of computing device 202 and the external computing device) responsive to a user registering the external computing device to an account associated with the user and/or computing device 202 (e.g., initiate enrollment responsive to a user of computing device 202 pairing computing device 202 with the external computing device).

Enrollment module 232 may determine a measured distance between computing device 202 and a device to be enrolled based on a signal metric determined using one or more enrollment ranging signals. For example, enrollment module 232 may determine a measured distance based on a speed of enrollment ranging signals (e.g., speed of light) and a signal metric. For instance, enrollment module 232 may compute, based on an enrollment ranging signal and a response signal, a one-way propagation time by dividing the difference of a signal metric and a turnaround time by two. Enrollment module 232 may determine a measured distance by multiplying a one-way propagation time by a speed of an enrollment ranging signal.

Enrollment module 232 may determine an offset distance for an enrollment ranging signal based on a comparison of a measured distance (e.g., measured using wireless ranging protocols) and a set distance. For example, enrollment module 232 may determine an offset distance by comparing a measured distance to a set distance associated with a distance between a housing of computing device 202 and a device to be enrolled. Enrollment module 232 may determine an offset distance by, for example, subtracting a measured distance from a set distance such that the offset distance indicates a distance of internal, wireless communication components of computing device 202 and a device to be enrolled. Enrollment module 232 may send an indication of a determined offset distance and an indication of a corresponding pair of computing device 202 and a device to be enrolled to profile generator 234.

Profile generator 234 may include computer readable instructions for generating device-pair calibration profiles stored as device pair profiles 218. For example, profile generator 234 may generate a device-pair calibration profile as a mapping of an offset distance, obtained from enrollment module 232, to an indication of a pair of computing device 202 and a device to be enrolled. In some examples, profile generator 234 may generate device-pair calibration profiles with positional information associated with a position or orientation of computing device 202 when enrollment module 232 was determining a distance. For example, profile generator 234 may obtain positional information as a particular offset distance determined during an enrollment period that indicates a baseline position associated with how a user holds or wears computing device 202 to trigger actions based on distance determinations. In some instances, profile generator 234 may obtain, with explicit user consent, positional information as indications of a baseline position associated with utilization of computing device 202 (e.g., angles, orientations, or other information associated with how a user operates computing device 202 in various instances that may be obtained using positional sensors of user interface components 212). Profile generator 234 may update device-pair calibration profiles based on positional information. For example, profile generator 234 may update an offset distance of a device-pair calibration profile to include indications of a position or orientation of computing device 202 (e.g., include an angle of computing device 202 with respect to a horizon).

In situations in which the systems discussed here collect personal information about users, or may make use of personal information, the users may be provided with an opportunity to control whether programs or features collect user information (e.g. , information about a user’s social network, social actions or activities, profession, a user’s preferences, or a user’s current location), or to control whether and/or how to receive content from the content server that may be more relevant to the user. In addition, certain data may be treated in one or more ways before it is stored or used, so that personally identifiable information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over how information is collected about the user and used by computing device 202 and/or a content server.

Device-pair activity monitor 228 may be employed by applications 206 to suggest and/or perform recalibration of device-pair calibration profiles of device pair profiles 218. Device-pair activity monitor 228 may include computer readable instructions for collecting data associated with distance determinations for triggering actions. For example, device-pair activity monitor 228 may collect feedback data associated with whether an action was appropriately triggered responsive to a determined distance. In another example, device-pair activity monitor 228 may collect data associated with an accuracy of distances determined between computing device 202 and a device enrolled with a device-pair calibration profile.

Device-pair activity monitor 228 may include one or more machine learning (ML) models 238 and recalibration module 242. In one example, one or more ML models 238 may include a machine learning model trained to predict whether an offset distance associated with a device-pair calibration profile may need to be recalibrated. For example, device-pair activity monitor 228 may provide the machine learning model data associated with distance determinations for triggering actions. The machine learning model may process the data and output an indication that an accuracy of device determinations does not satisfy an accuracy threshold and/or an indication that actions have been triggered based on incorrect distance determinations. The machine learning model may send an indication that a device-pair calibration profile may need to be updated to recalibration module 242.

Recalibration module 242 may initiate recalibration of a device-pair calibration profile for a pair of computing device 202 and an enrolled device. For example, recalibration module 242 may receive, based on an indication received via a user interface displayed at UIC 212, an indication of recalibration for distance determinations between computing device 202 and an enrolled device. Recalibration module 242 may instruct UI module 236 to generate and output, for display via UIC 212, data for a user interface including text data indicating instructions to place computing device 202 at a set distance (e.g., thirty centimeters) from an enrolled device. In some instances, recalibration module 242 may instruct UI module 236 to include text data indicating instructions to place computing device 202 at a set distance from an enrolled device and at an orientation or position associated with triggering a particular action. Recalibration module 242 may determine, based on user inputs applied to the user interface displayed via UIC 212 (e.g., a user input confirming computing device 202 is placed at a set distance from an enrolled device), computing device 202 is positioned at a set distance from an enrolled device. Recalibration module 242 may send the set distance to ranging calibrator 204 to determine an offset distance, based at least on the set distance, for a pair of computing device 202 and the enrolled device and update a corresponding device-pair calibration profile accordingly. In some instances, recalibration module 242 may initiate recalibration in periodic intervals (e.g., every month).

In some examples, calibration UI/UX 226 may initiate device-pair calibration profile generation. Calibration UI/UX 226 may include computer readable instructions for coordinating user interfaces and user inputs associated with enrolling a device. For example, calibration UI/UX 226 may include one or more application programming interfaces (APIs) that enable applications 206 to use ranging calibrator 204 to generate device-pair calibration profiles for particular external devices (e.g., a companion computing device, IOT devices, smart home devices, vehicles, etc.). Calibration UI/UX 226 may generate user interfaces and/or user experiences associated with enrolling devices using ranging calibrator 204. For example, calibration UI/UX 226 may generate a user interface, for a particular application of applications 206 requesting to generate a device-pair calibration profile for triggering a particular action, with a user experience instructing a user of computing device 202 to establish a set distance for offset distance determinations.

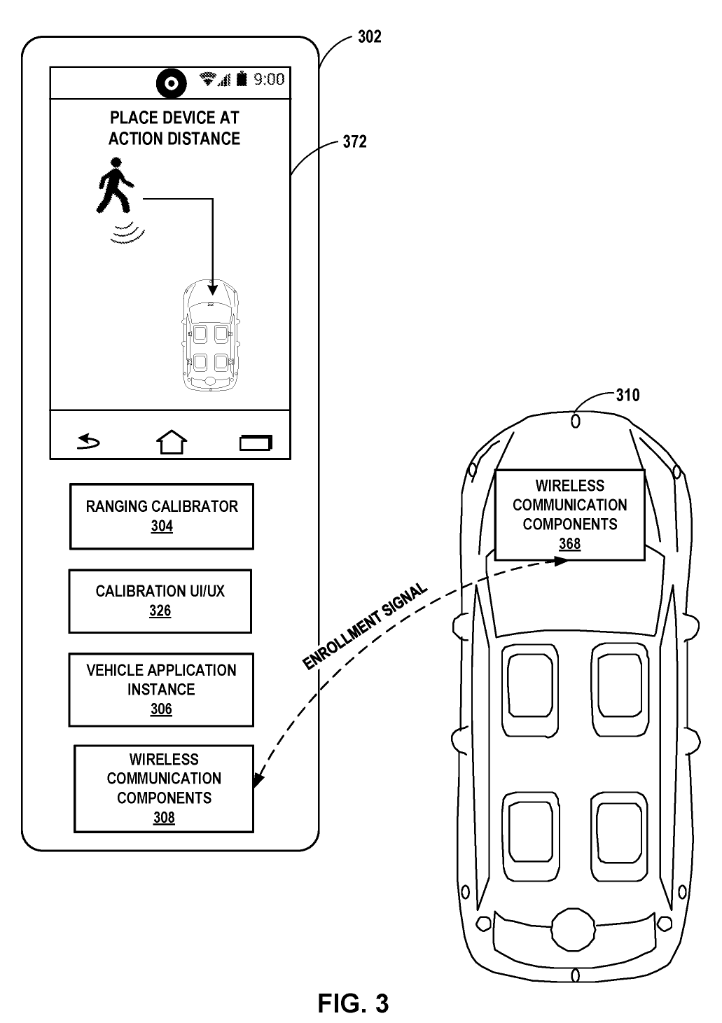

FIG. 3 is a conceptual diagram illustrating one example of first example computing device 302 performing wireless ranging calibration with an example second computing device 310 to determine a device pair profile, in accordance with aspects of the present disclosure. Computing device 302, computing device 310, ranging calibrator 304, vehicle application instance 306, and wireless communication components 308 of FIG. 3 may be example or alternative implementations of computing device 102, any of computing devices 110, ranging calibrator 304, applications 306, and wireless communication components 108 of FIG. 1, respectively. Additionally, or alternatively, computing device 302, ranging calibrator 304, calibration UI/UX 326, vehicle application 306, and wireless communication components 308 of FIG. 3 may be example or alternative implementations of computing device 202, ranging calibrator 204, calibration UI/UX 226, vehicle application 206, and wireless communication components 208 of FIG. 2, respectively.

In the example of FIG. 3, calibration UI/UX 326 may coordinate enrollment of computing device 310 to generate a device-pair calibration for a pair of computing device 302 and computing device 310. Calibration UI/UX 326 may interface with vehicle application instance 306 to output user interfaces for a user experience associated with calibrating an action, associated with vehicle application instance 306, triggered based on a determined distance. For example, calibration UI/UX 326 may interface with vehicle application instance 306 to enroll an action of triggering an unlock procedure associated with computing device 310 (e.g., trigger unlocking a door of a vehicle associated with computing device 310).

Calibration UI/UX 326 may initiate enrollment of computing device 310 via user interface 372. Calibration UI/UX 326 may request a user input an action distance (e.g., 1 foot) associated with triggering an action (e.g., unlock procedure associated with computing device 310). Calibration UI/UX 326 may output user interface 372 to include text data of instructions for a user operating computing device 302 to place computing device 302 at an action distance (e.g., set by the user). In some examples, calibration UI/UX 326 may output user interface 376 to include text data for a user operating computing device 302 to place computing device 302 at an action distance, as well as in an orientation in which a to be enrolled action is typically performed. Calibration UI/UX 326 may determine, based on receiving a user input associated with user interface 372 indicating computing device 302 is in the requested position, computing device 302 is positioned at a set position including positional information associated with an action distance and/or an orientation of computing device 302. Calibration UI/UX 326 may provide the set position to ranging calibrator 304.

Ranging calibrator 304 may generate a device-pair calibration profile that includes calibration information associated with triggering an action associated with vehicle application instance 306 responsive to an action distance and/or orientation. Ranging calibrator 304 may send an enrollment signal to wireless communication components 368 of computing device 310 to determine an offset distance associated with an action distance and/or orientation of computing device 302. Ranging calibrator 304 may store a mapping of the determined offset distance to an action associated with the enrollment signal in a device-pair calibration profile for a pair of computing device 302 and computing device 310.

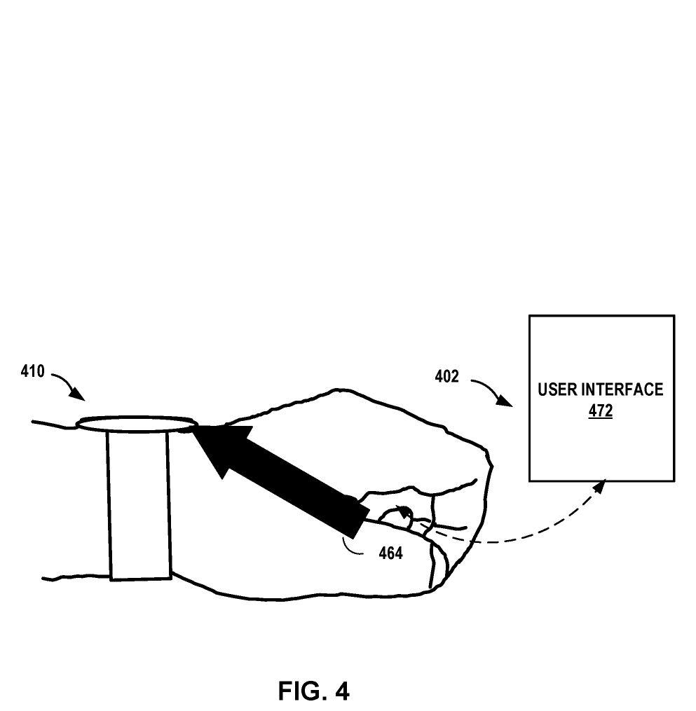

FIG. 4 is a conceptual diagram illustrating one example of first example computing device 402 performing wireless ranging calibration with example second computing device 410 to determine a device pair profile, in accordance with one or more aspects of the present disclosure. Computing device 402, user interface 472, and computing device 410 of FIG. 4 may be an example or alternative implementations of computing device 302, user interface 372, and computing device 310 of FIG. 3, respectively.

In the example of FIG. 4, computing device 402 may output user interface 472 including text data indicating instructions for a user to place computing device in a hand of the user in which a computing device 410 is worn. Computing device 402 may receive, based on user inputs associated with user interface 472, an indication that computing device 402 is positioned in the hand of the user with orientations of computing device 410 and computing device 402 associated with a baseline use of computing device 410 and computing device 402. Computing device 402 may send an enrollment signal to computing device 410 to determine an offset distance associated with wireless communication components of computing device 402 and wireless communication components of computing device 410. In the example of FIG. 4, computing device 402 may estimate set distance 464 (e.g., a set distance including positional information associated with a user’s baseline use of computing device 402 and computing device 410) for offset distance determinations as an average distance associated with a hand (e.g., 10 centimeters). Computing device 402 may generate and/or update a device-pair profile for a pair of computing device 402 and computing device 410 to include an offset distance labeled with an indication that the offset distance is associated with computing device 402 placed in a hand associated with computing device 410.

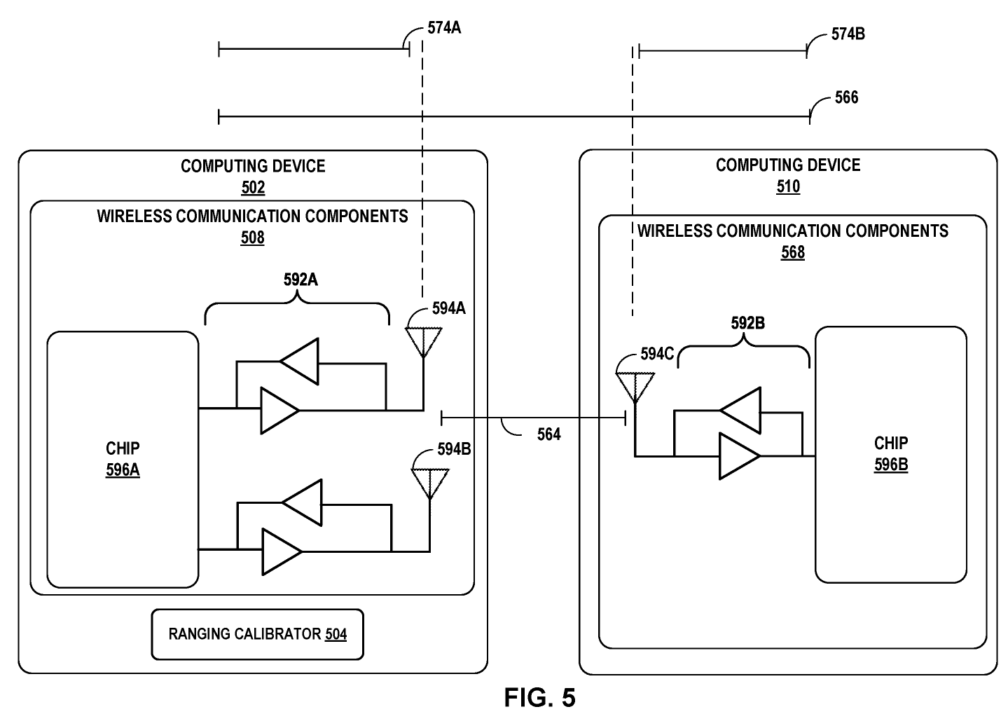

FIG. 5 is a block diagram illustrating example offset distance 574A, 574B for a device pair profile associated with example first computing device 502 and example second computing device 510, in accordance with one or more aspects of the present disclosure. Computing device 502, wireless communication components 508, ranging calibrator 504, computing device 510, and wireless communication components 568 of FIG. 5 may be example or alternative implementations of computing device 302, wireless communication components 308, ranging calibrator 304, computing device 310, and wireless communication components 368 of FIG. 3, respectively.

In the example of FIG. 5, wireless communication components 508 of computing device 502 may include chip 596A, modules 592A, and antennas 594A, 594B. Wireless communication components 568 of computing device 510 may include chip 596B, modules 592B, and antenna 594C. Chips 596A, 596B may include UWB chips, BLE chips, WIFI chips, NFC chips, or any other hardware components for implementing functionalities of respective wireless communication components. Modules 592A, 592B may include one or more low noise amplifiers (LNAs), one or more power amplifiers (PAs), and/or one or more hardware components associated with a wireless ranging protocol. Antennas 594A, 594B, 594C may include UWB antennas, BLE antennas, WIFI antennas, or any other antenna for sending and receiving signals for wireless ranging protocols.

In the example of FIG. 5, ranging calibrator 504 may determine set distance 564 to be an actual distance between antennas 594A, 594B of wireless communication components 508 and antenna 594C of wireless communication components 568 (e.g., when computing device 502 and/or computing device 510 have a particular orientation associated with triggering actions). Ranging calibrator 504 may process an enrollment signal communicated with computing device 510 to determine measured distance 566 using one or more wireless ranging protocols associated with the enrollment signal. Ranging calibrator 504 may determine offset distances 574A, 574B based on set distance 564 and measured distance 566. For example, ranging calibrator 504 may subtract a value of measured distance 566 by a value of set distance 564 to determine offset distances 574A, 574B. Ranging calibrator 504 may store offset distances 574A, 574B in a device pair calibration profile for a pair of computing device 502 and computing device 510 to quickly and accurately determine a distance between computing device 502 and computing device 510 for triggering actions.

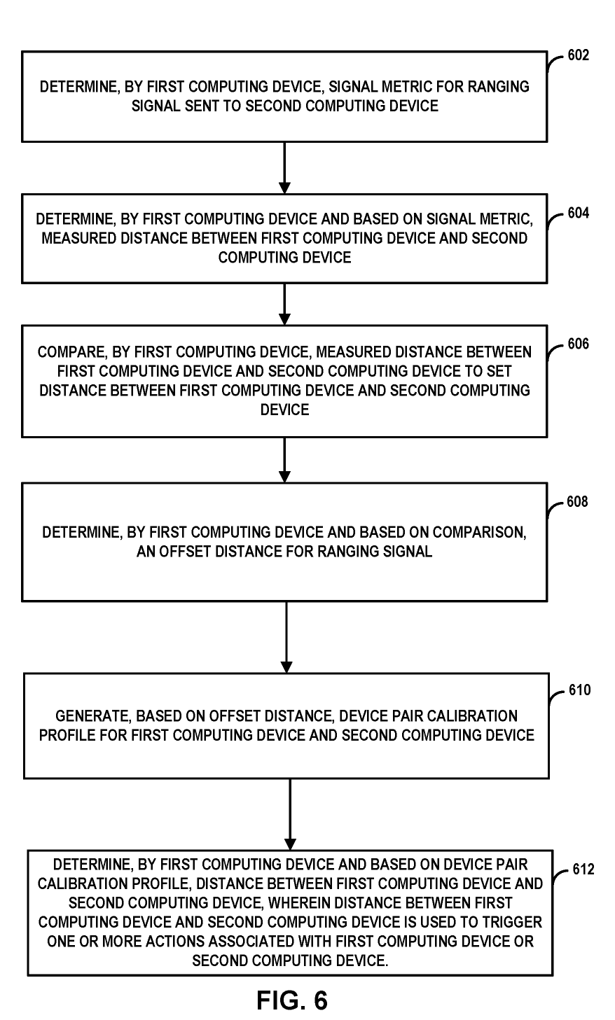

FIG. 6 is a flow diagram illustrating an operation for determining a device pair calibration profile, in accordance with one or more aspects of the present disclosure. FIG. 6 may be discussed with respect to FIG. 1 for example purposes only.

Computing device 102 may determine a signal metric for a ranging signal sent to computing device 110N (602). Computing device 102 may determine, based on the signal metric, a measured distance between computing device 102 and computing device 110N (604). Computing device 102 may compare the measured distance between computing device 102 and computing device 110N to a set distance between computing device 102 and computing device 110N (606). Computing device 102 may determine, based on the comparison of the measured distance to the set distance, an offset distance for the ranging signal (608). Computing device 102 may generate, based on the offset distance, a device pair calibration profile for computing device 102 and computing device 110N (610). Computing device 102 may determine, based on the device pair calibration profile, a distance between computing device 102 and computing device 110N, wherein the distance is used to trigger one or more actions associated with computing device 102 and/or computing device 110N (612).

This disclosure includes the following examples.

Example 1: A method includes determining, by a first computing device, a signal metric for a ranging signal sent to a second computing device; determining, by the first computing device and based on the signal metric, a measured distance between the first computing device and the second computing device; comparing, by the first computing device, the measured distance between the first computing device and the second computing device to a set distance between the first computing device and the second computing device; determining, by the first computing device and based on the comparison, an offset distance for the ranging signal; generating, based on the offset distance, a device-pair calibration profile for the first computing device and the second computing device; and determining, by the first computing device and based on the device-pair calibration profile, a distance between the first computing device and the second computing device, wherein the distance between the first computing device and the second computing device is used to trigger one or more actions associated with the first computing device or the second computing device.

Example 2: The method of example 1, wherein the signal metric is an enrollment signal metric and the ranging signal is an enrollment ranging signal, and wherein determining the distance between the first computing device and the second computing device comprises: determining a second signal metric for a second ranging signal sent to the second computing device; and computing, based on the device-pair calibration profile and the second signal metric, the distance between the first computing device and the second computing device.

Example 3: The method of any of examples 1 and 2, further includes calibrating a wireless ranging system associated with the first computing device based on the device-pair calibration profile.

Example 4: The method of any of examples 1 through 3, wherein the offset distance is a distance associated signal delays of wireless communication components of the first computing device and the second computing device sending and receiving data associated with the ranging signal.

Example 5: The method of any of examples 1 through 4, wherein the first computing device generates the device-pair calibration profile during enrollment of the second computing device, the enrollment of the second computing device initiated by a user of the first computing device via a user interface.

Example 6: The method of example 5, further includes outputting the user interface for display at the first computing device, wherein the user interface includes instructions for the user to place the first computing device at the set distance from the second computing device; and determining, based on user inputs associated with the user interface, the first computing device is positioned at the set distance from the second computing device.

Example 7: The method of any of examples 1 through 6, wherein the signal metric is a first signal metric, the ranging signal is a first ranging signal, the measured distance is a first measured distance, the set distance is a first set distance, and the offset distance is a first offset distance, and wherein the method further comprises: in response to receiving an indication of recalibration via a user interface displayed at the first computing device, outputting, by the first computing device and for display, instructions to place the first computing device at a second set distance from the second computing device; determining, by the first computing device and based on user inputs associated with the user interface, the first computing device is positioned at the second set distance from the second computing device; determining, by the first computing device, a second signal metric for a second ranging signal sent to the second computing device; determining, by the first computing device and based on the second signal metric, a second measured distance between the first computing device and the second computing device; comparing, by the first computing device, the second measured distance to the second set distance; determining, by the first computing device and based on the comparison of the second measured distance to the second set distance, a second offset distance for the second ranging signal; and updating, based on the second offset distance, the device-pair calibration profile for the first computing device and the second computing device.

Example 8: The method of any of examples 1 through 7, further includes obtaining positional information for the first computing device, the positional information indicating a baseline position associated utilization of the first computing device; and updating the device-pair calibration profile based on the positional information.

Example 9: The method of any of examples 1 through 8, wherein the one or more actions associated with the first computing device or the second computing device includes triggering, responsive to the distance between the first computing device and the second computing device satisfying a threshold, an unlock procedure between the first computing device and the second computing device.

Example 10: The method of any of examples 1 through 9, wherein the one or more actions are performed by software application instances executing at the first computing device and the second computing device.

Example 11: The method of any of examples 1 through 10, wherein determining the measured distance between the first computing device and the second computing device comprises determining the measured distance using a wireless ranging protocol associated with the signal metric, wherein the wireless ranging protocol includes one of: an ultra-wideband protocol, a personal area network channel sounding protocol, or a local area network round trip time protocol.

Example 12: The method of any of examples 1 through 11, wherein the ranging signal is a first ranging signal, the signal metric is a first signal metric, the measured distance is a first measured distance, the set distance is a first set distance, the offset distance is a first offset distance, and the device-pair calibration profile is a first device-pair calibration profile, and wherein the method further comprises: determining, by the first computing device, a second signal metric for a second ranging signal sent to a third computing device; determining, by the first computing device and based on the second signal metric, a second measured distance between the first computing device and the third computing device; comparing, by the first computing device, the second measured distance between the first computing device and the third computing device to a second set distance between the first computing device and the third computing device; determining, by the first computing device and based on the comparison, a second offset distance for the second ranging signal; generating, based on the second offset distance, a second device-pair calibration profile for the first computing device and the third computing device; and determining, by the first computing device and based on the second device-pair calibration profile, a distance between the first computing device and the third computing device.

Example 13: A computing device includes one or more processors; and a storage device that stores instructions executable by the one or more processors to: determine a signal metric for a ranging signal sent to an external computing device; determine, based on the signal metric, a measured distance between the computing device and the external computing device; compare the measured distance between the computing device and the external computing device to a set distance between the computing device and the external computing device; determine, based on the comparison of the measured distance to the set distance, an offset distance for the ranging signal; generate, based on the offset distance, a device-pair calibration profile for the computing device and the external computing device; and determine, based on the device-pair calibration profile, a distance between the computing device and the external computing device, wherein the distance between the computing device and the external computing device is used to trigger one or more actions associated with the computing device or the external computing device.

Example 14: The computing device of example 13, wherein the signal metric is an enrollment signal metric and the ranging signal is an enrollment ranging signal, and wherein to determine the distance between the computing device and the external computing device, the storage device stores instructions executable by the one or more processors to: determine a second signal metric for a second ranging signal sent to the external computing device; and compute, based on the device-pair calibration profile and the second signal metric, the distance between the computing device and the external computing device.

Example 15: The computing device of any of examples 13 and 14, wherein the storage device further stores instructions executable by the one or more processors to calibrate a wireless ranging system associated with the first computing device based on the device-pair calibration profile.

Example 16: The computing device of any of examples 13 through 15, wherein the offset distance is a distance associated signal delays of wireless communication components of the computing device and the external computing device sending and receiving data associated with the ranging signal.

Example 17: The computing device of any of examples 13 through 16, wherein the storage device stores instructions executable by the one or more processors to generate the device-pair calibration profile during enrollment of the external computing device, the enrollment of the external computing device initiated by a user of the computing device via a user interface.

Example 18: The computing device of example 17, wherein the storage device further stores instructions executable by the one or more processors to: output the user interface for display at the computing device, wherein the user interface includes instructions for the user to place the computing device at the set distance from the external computing device; and determining, based on user inputs associated with the user interface, the computing device is positioned at the set distance from the external computing device.

Example 19: The computing device of any of examples 13 through 18, wherein the signal metric is a first signal metric, the ranging signal is a first ranging signal, the measured distance is a first measured distance, the set distance is a first set distance, and the offset distance is a first offset distance, and wherein the storage device further stores instructions executable by the one or more processors to: in response to receiving an indication of recalibration via a user interface displayed at the computing device, output, for display, instructions to place the computing device at a second set distance from the external computing device; determine, based on user inputs associated with the user interface, the computing device is positioned at the second set distance from the external computing device; determine a second signal metric for a second ranging signal sent to the external computing device; determine, based on the second signal metric, a second measured distance between the computing device and the external computing device; compare the second measured distance to the second set distance; determine, based on the comparison of the second measured distance to the second set distance, a second offset distance for the second ranging signal; and update, based on the second offset distance, the device-pair calibration profile for the computing device and the external computing device.

Example 20: The computing device of any of examples 13 through 19, wherein the storage device further stores instructions executable by the one or more processors to: obtain positional information for the computing device, the positional information indicating a baseline position associated utilization of the computing device; and update the device-pair calibration profile based on the positional information.

Example 21: The computing device of any of examples 13 through 20, wherein the one or more actions associated with the computing device or the external computing device includes triggering, responsive to the distance between the computing device and the external computing device satisfying a threshold, an unlock procedure between the computing device and the external computing device.

Example 22: The computing device of any of examples 13 through 21, wherein the one or more actions are performed by software application instances executing at the computing device and the external computing device.

Example 23: The computing device of any of examples 13 through 22, wherein to determine the measured distance between the computing device and the external computing device, the storage device stores instructions executable by the one or more processors to: determine the measured distance using a wireless ranging protocol associated with the signal metric, wherein the wireless ranging protocol includes one of: an ultra-wideband protocol, a personal area network channel sounding protocol, or a local area network round trip time protocol.

Example 24: The computing device of any of examples 13 through 23, wherein the ranging signal is a first ranging signal, the signal metric is a first signal metric, the measured distance is a first measured distance, the set distance is a first set distance, the offset distance is a first offset distance, and the device-pair calibration profile is a first device-pair calibration profile, and wherein the storage device further stores instructions executable by the one or more processors to: determine a second signal metric for a second ranging signal sent to a second external computing device; determine, based on the second signal metric, a second measured distance between the computing device and the second external computing device; compare the second measured distance between the computing device and the second external computing device to a second set distance between the computing device and the second external computing device; determine, based on the comparison of the second measured distance to the second set distance, a second offset distance for the second ranging signal; generate, based on the second offset distance, a second device-pair calibration profile for the computing device and the second external computing device; and determine, based on the second device-pair calibration profile, a distance between the computing device and the second external computing device.

Example 25: Computer-readable storage media encoded with instructions that cause a computing device to: determine a signal metric for a ranging signal sent to an external computing device; determine, based on the signal metric, a measured distance between the computing device and the external computing device; compare the measured distance between the computing device and the external computing device to a set distance between the computing device and the external computing device; determine, based on the comparison of the measured distance to the set distance, an offset distance for the ranging signal; generate, based on the offset distance, a device-pair calibration profile for the computing device and the external computing device; and determine, based on the device-pair calibration profile, a distance between the computing device and the external computing device, wherein the distance between the computing device and the external computing device is used to trigger one or more actions associated with the computing device or the external computing device.

Example 26: The computer-readable storage media of example 25, wherein the signal metric is an enrollment signal metric and the ranging signal is an enrollment ranging signal, and wherein to determine the distance between the computing device and the external computing device, the instructions cause the computing device to: determine a second signal metric for a second ranging signal sent to the external computing device; and compute, based on the device-pair calibration profile and the second signal metric, the distance between the computing device and the external computing device.

Example 27: The computer-readable storage media of any of examples 25 and 26, wherein the instructions further cause the computing device to calibrate a wireless ranging system associated with the first computing device based on the device-pair calibration profile.

Example 28: The computer-readable storage media of any of examples 25 through 27, wherein the offset distance is a distance associated signal delays of wireless communication components of the computing device and the external computing device sending and receiving data associated with the ranging signal.

Example 29: The computer-readable storage media of any of examples 25 through 28, wherein the instructions cause the computing device to generate the device-pair calibration profile during enrollment of the external computing device, the enrollment of the external computing device initiated by a user of the computing device via a user interface.

Example 30: The computer-readable storage media of example 29, wherein the instructions further cause the computing device to: output the user interface for display at the computing device, wherein the user interface includes instructions for the user to place the computing device at the set distance from the external computing device; and determining, based on user inputs associated with the user interface, the computing device is positioned at the set distance from the external computing device.

Example 31: The computer-readable storage media of any of examples 25 through 30, wherein the signal metric is a first signal metric, the ranging signal is a first ranging signal, the measured distance is a first measured distance, the set distance is a first set distance, and the offset distance is a first offset distance, and wherein the instructions further cause the computing device to: in response to receiving an indication of recalibration via a user interface displayed at the computing device, output, for display, instructions to place the computing device at a second set distance from the external computing device; determine, based on user inputs associated with the user interface, the computing device is positioned at the second set distance from the external computing device; determine a second signal metric for a second ranging signal sent to the external computing device; determine, based on the second signal metric, a second measured distance between the computing device and the external computing device; compare the second measured distance to the second set distance; determine, based on the comparison of the second measured distance to the second set distance, a second offset distance for the second ranging signal; and update, based on the second offset distance, the device-pair calibration profile for the computing device and the external computing device.

Example 32: The computer-readable storage media of any of examples 25 through 31, wherein the instructions further cause the computing device to: obtain positional information for the computing device, the positional information indicating a baseline position associated utilization of the computing device; and update the device-pair calibration profile based on the positional information.

Example 33: The computer-readable storage media of any of examples 25 through 32, wherein the one or more actions associated with the computing device or the external computing device includes triggering, responsive to the distance between the computing device and the external computing device satisfying a threshold, an unlock procedure between the computing device and the external computing device.

Example 34: The computer-readable storage media of any of examples 25 through 33, wherein the one or more actions are performed by software application instances executing at the computing device and the external computing device.

Example 35: The computer-readable storage media of any of examples 25 through 34, wherein to determine the measured distance between the computing device and the external computing device, the instructions cause the computing device to: determine the measured distance using a wireless ranging protocol associated with the signal metric, wherein the wireless ranging protocol includes one of: an ultra-wideband protocol, a personal area network channel sounding protocol, or a local area network round trip time protocol.

Example 36: The computer-readable storage media of any of examples 25 through 35, wherein the ranging signal is a first ranging signal, the signal metric is a first signal metric, the measured distance is a first measured distance, the set distance is a first set distance, the offset distance is a first offset distance, and the device-pair calibration profile is a first device-pair calibration profile, and wherein the instructions further cause the computing device to: determine a second signal metric for a second ranging signal sent to a second external computing device; determine, based on the second signal metric, a second measured distance between the computing device and the second external computing device; compare the second measured distance between the computing device and the second external computing device to a second set distance between the computing device and the second external computing device; determine, based on the comparison of the second measured distance to the second set distance, a second offset distance for the second ranging signal; generate, based on the second offset distance, a second device-pair calibration profile for the computing device and the second external computing device; and determine, based on the second device-pair calibration profile, a distance between the computing device and the second external computing device.

Example 38: A computing system comprising means for performing any of the methods of examples 1-12.

Example 39: Computer-readable storage media encoded with instructions that cause a computing system to perform any of the methods of examples 1-12.

Example 40: A computer program product comprising at least one non-transitory computer readable media including one or more instructions that, when executed by at least one processor, cause the at least one processor to perform any of the methods of examples 1-12.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structures or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium includes a non-transitory medium. In some examples, the term “non-transitory” indicates that the storage medium is not embodied in a carrier wave or a propagated signal. In certain examples, a non-transitory storage medium may store data that can, over time, change (e.g., in RAM or cache). Although certain examples are described as outputting various information for display, techniques of the disclosure may output such information in other forms, such as audio, holographical, or haptic forms, to name only a few examples, in accordance with techniques of the disclosure.

Various examples have been described. These and other examples are within the scope of the following claims.

What is claimed is:

1. A method comprising:
determining, by a first computing device, a signal metric for a ranging signal sent to a second computing device;
determining, by the first computing device and based on the signal metric, a measured distance between the first computing device and the second computing device;
comparing, by the first computing device, the measured distance between the first computing device and the second computing device to a set distance between the first computing device and the second computing device;
determining, by the first computing device and based on the comparison, an offset distance for the ranging signal;
generating, based on the offset distance, a device-pair calibration profile for the first computing device and the second computing device; and
determining, by the first computing device and based on the device-pair calibration profile, a distance between the first computing device and the second computing device, wherein the distance between the first computing device and the second computing device is used to trigger one or more actions associated with the first computing device or the second computing device.

2. The method of claim 1, wherein the signal metric is an enrollment signal metric and the ranging signal is an enrollment ranging signal, and wherein determining the distance between the first computing device and the second computing device comprises:
determining a second signal metric for a second ranging signal sent to the second computing device; and
computing, based on the device-pair calibration profile and the second signal metric, the distance between the first computing device and the second computing device.

3. The method of claim 1, wherein the offset distance is a distance associated signal delays of wireless communication components of the first computing device and the second computing device sending and receiving data associated with the ranging signal.

4. The method of claim 1, wherein the first computing device generates the device-pair calibration profile during enrollment of the second computing device, the enrollment of the second computing device initiated by a user of the first computing device via a user interface.

5. The method of claim 1, wherein the signal metric is a first signal metric, the ranging signal is a first ranging signal, the measured distance is a first measured distance, the set distance is a first set distance, and the offset distance is a first offset distance, and wherein the method further comprises:
in response to receiving an indication of recalibration via a user interface displayed at the first computing device, outputting, by the first computing device and for display, instructions to place the first computing device at a second set distance from the second computing device;
determining, by the first computing device and based on user inputs associated with the user interface, the first computing device is positioned at the second set distance from the second computing device;
determining, by the first computing device, a second signal metric for a second ranging signal sent to the second computing device;
determining, by the first computing device and based on the second signal metric, a second measured distance between the first computing device and the second computing device;
comparing, by the first computing device, the second measured distance to the second set distance;
determining, by the first computing device and based on the comparison of the second measured distance to the second set distance, a second offset distance for the second ranging signal; and
updating, based on the second offset distance, the device-pair calibration profile for the first computing device and the second computing device.

6. The method of claim 1, further comprising:
obtaining positional information for the first computing device, the positional information indicating a baseline position associated utilization of the first computing device; and
updating the device-pair calibration profile based on the positional information.

7. The method of claim 1, wherein the one or more actions associated with the first computing device or the second computing device includes triggering, responsive to the distance between the first computing device and the second computing device satisfying a threshold, an unlock procedure between the first computing device and the second computing device.

8. The method of claim 1, wherein determining the measured distance between the first computing device and the second computing device comprises determining the measured distance using a wireless ranging protocol associated with the signal metric, wherein the wireless ranging protocol includes one of: an ultra-wideband protocol, a personal area network channel sounding protocol, or a local area network round trip time protocol.

9. The method of claim 1, wherein the ranging signal is a first ranging signal, the signal metric is a first signal metric, the measured distance is a first measured distance, the set distance is a first set distance, the offset distance is a first offset distance, and the device-pair calibration profile is a first device-pair calibration profile, and wherein the method further comprises:
determining, by the first computing device, a second signal metric for a second ranging signal sent to a third computing device;
determining, by the first computing device and based on the second signal metric, a second measured distance between the first computing device and the third computing device;
comparing, by the first computing device, the second measured distance between the first computing device and the third computing device to a second set distance between the first computing device and the third computing device;
determining, by the first computing device and based on the comparison, a second offset distance for the second ranging signal;
generating, based on the second offset distance, a second device-pair calibration profile for the first computing device and the third computing device; and
determining, by the first computing device and based on the second device-pair calibration profile, a distance between the first computing device and the third computing device.

10. A computing device comprising:
one or more processors; and
a storage device that stores instructions executable by the one or more processors to:
determine a signal metric for a ranging signal sent to an external computing device;
determine, based on the signal metric, a measured distance between the computing device and the external computing device;
compare the measured distance between the computing device and the external computing device to a set distance between the computing device and the external computing device;
determine, based on the comparison of the measured distance to the set distance, an offset distance for the ranging signal;
generate, based on the offset distance, a device-pair calibration profile for the computing device and the external computing device; and
determine, based on the device-pair calibration profile, a distance between the computing device and the external computing device, wherein the distance between the computing device and the external computing device is used to trigger one or more actions associated with the computing device or the external computing device.

11. The computing device of claim 10, wherein the signal metric is an enrollment signal metric and the ranging signal is an enrollment ranging signal, and wherein to determine the distance between the computing device and the external computing device, the storage device stores instructions executable by the one or more processors to:
determine a second signal metric for a second ranging signal sent to the external computing device; and
compute, based on the device-pair calibration profile and the second signal metric, the distance between the computing device and the external computing device.

12. The computing device of claim 10, wherein the storage device stores instructions executable by the one or more processors to generate the device-pair calibration profile during enrollment of the external computing device, the enrollment of the external computing device initiated by a user of the computing device via a user interface.

13. The computing device of claim 10, wherein the signal metric is a first signal metric, the ranging signal is a first ranging signal, the measured distance is a first measured distance, the set distance is a first set distance, and the offset distance is a first offset distance, and wherein the storage device further stores instructions executable by the one or more processors to:
in response to receiving an indication of recalibration via a user interface displayed at the computing device, output, for display, instructions to place the computing device at a second set distance from the external computing device;
determine, based on user inputs associated with the user interface, the computing device is positioned at the second set distance from the external computing device;
determine a second signal metric for a second ranging signal sent to the external computing device;
determine, based on the second signal metric, a second measured distance between the computing device and the external computing device;
compare the second measured distance to the second set distance;
determine, based on the comparison of the second measured distance to the second set distance, a second offset distance for the second ranging signal; and
update, based on the second offset distance, the device-pair calibration profile for the computing device and the external computing device.

14. The computing device of claim 10, wherein the storage device further stores instructions executable by the one or more processors to:
obtain positional information for the computing device, the positional information indicating a baseline position associated utilization of the computing device; and
update the device-pair calibration profile based on the positional information.

15. The computing device of claim 10, wherein the ranging signal is a first ranging signal, the signal metric is a first signal metric, the measured distance is a first measured distance, the set distance is a first set distance, the offset distance is a first offset distance, and the device-pair calibration profile is a first device-pair calibration profile, and wherein the storage device further stores instructions executable by the one or more processors to:
determine a second signal metric for a second ranging signal sent to a second external computing device;
determine, based on the second signal metric, a second measured distance between the computing device and the second external computing device;
compare the second measured distance between the computing device and the second external computing device to a second set distance between the computing device and the second external computing device;
determine, based on the comparison of the second measured distance to the second set distance, a second offset distance for the second ranging signal;
generate, based on the second offset distance, a second device-pair calibration profile for the computing device and the second external computing device; and
determine, based on the second device-pair calibration profile, a distance between the computing device and the second external computing device.

16. Computer-readable storage media encoded with instructions that cause a computing device to:
determine a signal metric for a ranging signal sent to an external computing device;
determine, based on the signal metric, a measured distance between the computing device and the external computing device;
compare the measured distance between the computing device and the external computing device to a set distance between the computing device and the external computing device;
determine, based on the comparison of the measured distance to the set distance, an offset distance for the ranging signal;
generate, based on the offset distance, a device-pair calibration profile for the computing device and the external computing device; and
determine, based on the device-pair calibration profile, a distance between the computing device and the external computing device, wherein the distance between the computing device and the external computing device is used to trigger one or more actions associated with the computing device or the external computing device.

17. The computer-readable storage media of claim 16, wherein the signal metric is an enrollment signal metric and the ranging signal is an enrollment ranging signal, and wherein to determine the distance between the computing device and the external computing device, the instructions cause the computing device to:
determine a second signal metric for a second ranging signal sent to the external computing device; and
compute, based on the device-pair calibration profile and the second signal metric, the distance between the computing device and the external computing device.

18. The computer-readable storage media of claim 16, wherein the instructions cause the computing device to generate the device-pair calibration profile during enrollment of the external computing device, the enrollment of the external computing device initiated by a user of the computing device via a user interface.

19. The computer-readable storage media of claim 16, wherein the signal metric is a first signal metric, the ranging signal is a first ranging signal, the measured distance is a first measured distance, the set distance is a first set distance, and the offset distance is a first offset distance, and wherein the instructions further cause the computing device to:
in response to receiving an indication of recalibration via a user interface displayed at the computing device, output, for display, instructions to place the computing device at a second set distance from the external computing device;
determine, based on user inputs associated with the user interface, the computing device is positioned at the second set distance from the external computing device;
determine a second signal metric for a second ranging signal sent to the external computing device;
determine, based on the second signal metric, a second measured distance between the computing device and the external computing device;
compare the second measured distance to the second set distance;
determine, based on the comparison of the second measured distance to the second set distance, a second offset distance for the second ranging signal; and
update, based on the second offset distance, the device-pair calibration profile for the computing device and the external computing device.

20. The computer-readable storage media of claim 16, wherein the instructions further cause the computing device to:
obtain positional information for the computing device, the positional information indicating a baseline position associated utilization of the computing device; and
update the device-pair calibration profile based on the positional information.
